(19) United States
(12) Patent Application Publication
(10) Pub. No.: US 2005/0129426 A1
(43) Pub. Date: Jun. 16, 2005

(54) Photosensitive drum having a spacer and electrophotograhic image forming apparatus having the same

(75) Inventors: Koichi Tsunemi, Suwon-si (KR); Yong-baek Yoo, Suwon-si (KR); Chung-guk Baek, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/973,271

(22) Filed: Oct. 27, 2004

(30) Foreign Application Priority Data
Dec. 15, 2003 (KR) 2003-91172

(51) Int. Cl. G03G 15/00

(52) U.S. Cl. 399/159

(57) ABSTRACT

A photosensitive drum with a fixed photosensitive sheet on the outer circumference of a cylindrical body that defines an image forming area. A spacer is disposed on at least one end of the outer portion of the image forming area on the cylindrical body. The spacer pushes either an electrostatic charging roller or a developing roller, which access the photosensitive sheet during an image forming process, when a seam of the photosensitive sheet approaches either the electrostatic charging roller or the developing roller to distance either the electrostatic charging roller or the developing roller from the seam of the photosensitive sheet.

### CROSS-REFERENCE TO RELATED APPLICATIONS

This application claims the benefit of Korean Patent Application No. 2003-91172, filed on Dec. 15, 2003, in the Korean Intellectual Property Office, the disclosure of which is incorporated herein in its entirety by reference.

### BACKGROUND OF THE INVENTION

1. Field of the Invention

The present invention relates to a photosensitive drum and an electrophotographic image forming apparatus having the same, and more particularly, to a photosensitive drum with a fixed photosensitive sheet thereon and an electrophotographic image forming apparatus having the same.

2. Description of the Related Art

In general, electrophotographic image forming apparatuses print images on a sheet of paper by radiating light onto a photosensitive medium that is charged with a uniform electrostatic potential to form an electrostatic latent image, supplying a developing material to the electrostatic latent image to develop the electrostatic latent image, and transferring the developed image onto the paper to print the image.

A charger that charges the photoreceptor may be a non-contact type corona discharger, such as corotron or scorotron, or a contact type charger, such as an electrostatic charging roller. The disadvantages of the corona discharger include a high operating voltage and requiring an expensive high voltage power supply, and producing many substances such as ozone and nitrogen oxide. Consequently, electrostatic charging rollers that produce less harmful substances and stable charging efficiency are more commonly used.

For the photoreceptor, a photosensitive belt, or a photosensitive drum, may be used. The photosensitive drum is produced by either coating photosensitive materials on the outer circumference of a cylindrical body or by fixing a photosensitive sheet on the outer circumference of the cylindrical body. Recently, to obtain a photosensitive drum with a large diameter at a relatively low price, a photosensitive drum with a fixed photosensitive sheet on the outer circumference of a cylindrical body is used.

A seam is formed when the photosensitive sheet is fixed on the cylindrical body. When the electrostatic charging roller charges the photosensitive drum with the fixed photosensitive sheet on the cylindrical body, the electrostatic charging roller comes in contact with the seam and gets damaged by the impact. In addition, the electrophotographic image forming apparatus has a developing roller, which supplies the developing material to the electrostatic latent image, in a state of contacting or not contacting the photosensitive drum. The developing roller is also in danger of getting damaged because of the seam.

### SUMMARY OF THE INVENTION

Accordingly, it is an aspect of the present invention to provide an improved photosensitive drum that prevents damage caused by a seam of a photosensitive sheet to an electrostatic charging roller and other components that access the photosensitive drum during an image forming process, and an electrophotographic image forming apparatus including the same.

Additional aspects and/or advantages of the invention will be set forth in part in the description which follows and, in part, will be obvious from the description, or may be learned by practice of the invention.

The foregoing and/or other aspects of the present invention are achieved by providing a photosensitive drum comprising: a cylindrical body; a fixed photosensitive sheet to define an image forming area on an outer circumference of the cylindrical body and including a seam; a spacer disposed on an end of an outer portion of the image forming area on the cylindrical body to push an electrostatic charging roller or a developing roller, which access the photosensitive sheet during an image forming process, when the seam of the photosensitive sheet approaches the electrostatic charging roller or the developing roller, to thereby make distant the seam from the electrostatic charging roller or the developing roller.

The foregoing and/or other aspects of the present invention are achieved by providing an electrophotographic image forming apparatus comprising: a photosensitive drum, comprising: a cylindrical body, and a fixed photosensitive sheet defining an image forming area on an outer circumference of the cylindrical body and comprising a seam; and an electrostatic charging roller that rotates in contact with the photosensitive sheet to charge uniform electrostatic potential on a surface thereof, wherein the photosensitive drum further comprises a spacer disposed on an end of an outer portion of the image forming area on the cylindrical body to, thereby distance the electrostatic charging roller from the seam of the photosensitive sheet by pushing the electrostatic charging roller when the seam of the photosensitive sheet approaches the electrostatic charging roller.

Additionally, the electrophotographic image forming apparatus of the embodiment of the present invention further comprising a developing roller that supplies a developing material to an electrostatic latent image formed on the photosensitive sheet, wherein the spacer pushes the developing roller as the seam of the photosensitive sheet approaches the developing roller to distance the developing roller from the seam of the photosensitive sheet.

The electrophotographic image forming apparatus of the embodiment of the present invention further comprising: a rotatable gap controlling that is disposed on opposite ends of the developing roller and in contact with ends of an outer portion of the image forming area on the cylindrical body to a developing gap between the surface of the photosensitive sheet and an outer circumference of the developing roller, wherein the spacer pushes the gap controlling roller to distance the developing roller from the seam of the photosensitive sheet.

### BRIEF DESCRIPTION OF THE DRAWINGS

These and/or other aspects and advantages of the invention will become apparent and more readily appreciated from the following description of the embodiment, taken in conjunction with the accompanying drawings of which:

FIG. 1 is a structural diagram illustrating an electrophotographic image forming apparatus according to an embodiment of the present invention;

FIG. 2 is a perspective view of a photosensitive drum according to the embodiment of the present invention;

FIGS. 3 and 4 are cross-sectional views of a fixed photosensitive sheet of FIGS. 1 and 2;

FIGS. 5 and 6 are cross-sectional views taken along lines I-I′ and II-II′ of FIG. 2, respectively;

FIG. 7 is a perspective view illustrating a relationship between the photosensitive drum and an electrostatic charging roller of FIG. 1;

FIGS. 8 and 9 are cross-sectional views of the lower portion of FIG. 7;

FIG. 10 is a plan view illustrating a relationship between the photosensitive drum and a developing roller of FIG. 1;

FIG. 11 is a cross-sectional view of the lower portion of FIG. 10; and

FIG. 12 is another plan view illustrating a relationship between the photosensitive drum and the developing roller.

### DETAILED DESCRIPTION OF THE PREFERRED EMBODIMENTS

Reference will now be made in detail to the embodiment of the present invention, examples of which are illustrated in the accompanying drawings, wherein like reference numerals refer to the like elements throughout. The embodiments are described below to explain the present invention by referring to the figures.

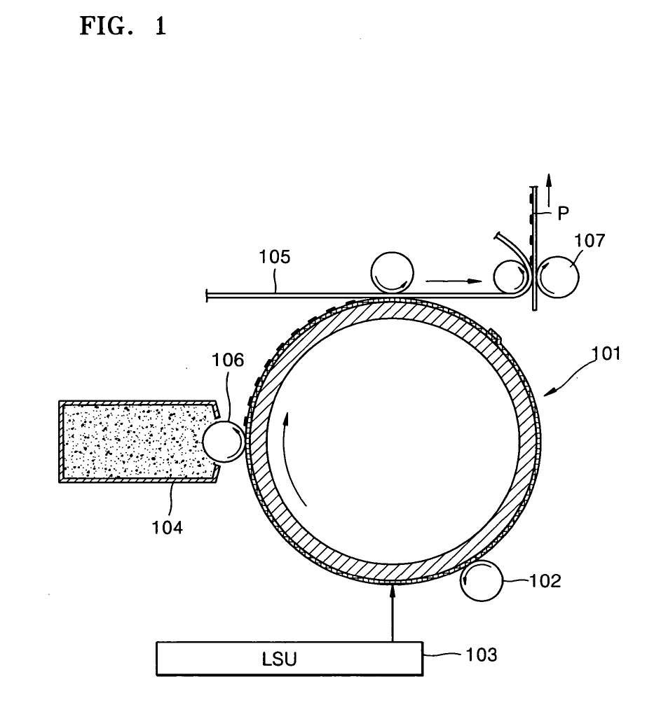

FIG. 1 is a sectional view illustrating an electrophotographic image forming apparatus according to an embodiment of the present invention. Referring to FIG. 1, a photosensitive drum 101, an electrostatic charging roller 102, an exposure unit 103, a developer 104, and a transfer belt 105 are illustrated. The electrostatic charging roller 102 rotates in contact with the photosensitive drum 101 and charges the surface of the photosensitive drum 101 with a uniform electrostatic potential. The exposure unit 103 radiates light corresponding to image information to the photosensitive drum 101 that is charged with uniform electrostatic potential to form an electrostatic latent image. For the exposure unit 103, a laser scanning unit (LSU), with laser diodes as the light source, is usually used. A developing material (hereinafter referred to as a toner) is housed inside the developer 104. A developing roller 106 supplies the toner to the electrostatic latent image formed on the photosensitive drum 101. The transfer belt 105 is an example of an intermediate transfer medium that receives a toner image from the photosensitive drum 101 and transfers the toner image to paper P.

The exposure unit 103 radiates light signals corresponding to the image information onto the photosensitive drum 101 that is charged with the uniform electrostatic potential. Then, the resistance of the part where the light is radiated decreases, and the electric charge attached to the outer circumference of the photosensitive drum 101 is discharged. As a result, a potential difference occurs between where the light is radiated and not radiated and thus, an electrostatic latent image forms on the outer circumference of the photosensitive drum 101. As the photosensitive drum 101 rotates and the electrostatic latent image approaches the developer 104, the toner housed in the developer 104 is attached to the electrostatic latent image and forms the toner image. When the toner image approaches the transfer belt 105 by the rotation of the photosensitive drum 101, the toner image transfers to the transfer belt 105 due to the potential difference and/or contact pressure with respect to the transfer belt 105. The toner image is transferred to paper P that passes between the transfer belt 105 and a transfer roller 107. A fixing unit (not shown) fixes the transferred toner image on paper P by heat and pressure.

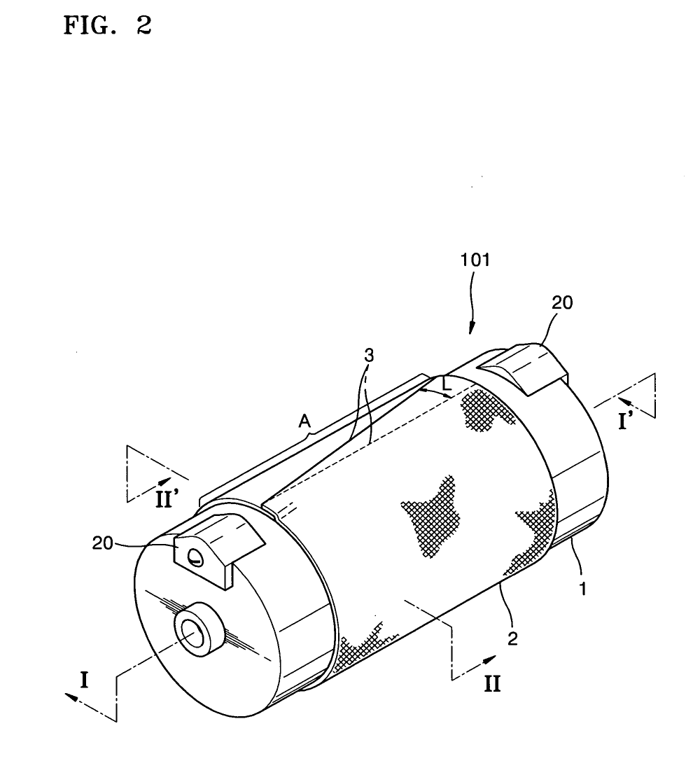

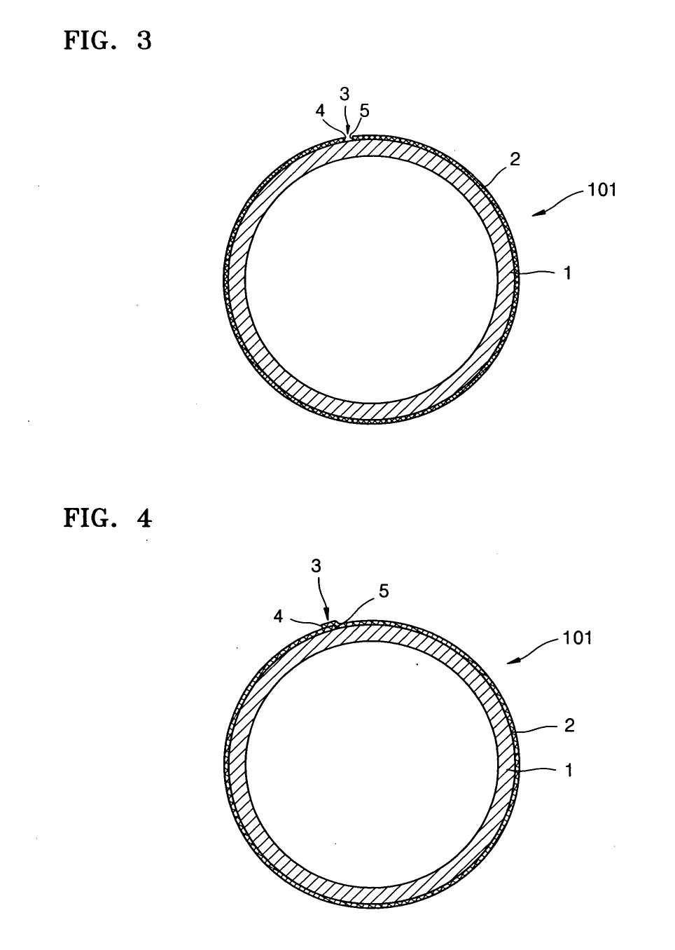

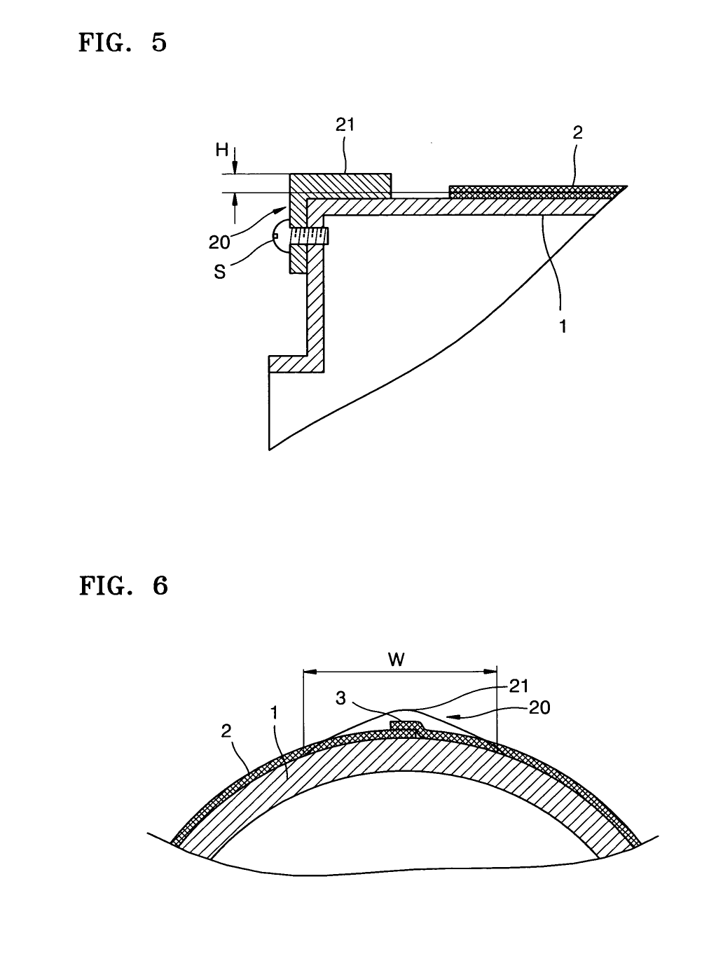

FIG. 2 is a perspective view of a photosensitive drum 101 according to an embodiment of the present invention. FIGS. 3 and 4 are cross-sectional views of a fixed photosensitive sheet 2 of the photosensitive drum 101. FIGS. 5 and 6 are portions of sectional views taken along lines I-I′ and II-II′ of FIG. 2, respectively.

Referring to FIG. 2, the photosensitive sheet 2 is fixed on the outer circumference of a cylindrical body 1. The photosensitive sheet 2 defines an image forming area “A” where an electrostatic latent image to create an image is formed. That is, the photosensitive sheet 2 includes a photosensitive layer formed on top of a plastic film deposited with an electrically conductive metal layer. Typically, a polyethylene terephthalate (PET) is used for the plastic film. When the photosensitive sheet 2 is adhered to the cylindrical body 1 using a double-sided adhesive tape, the thickness of the photosensitive sheet 2 including that of the double-sided tape is about 105-225 μm. As illustrated in FIG. 3, both ends 4 and 5 of the photosensitive sheet 2 are fixed exactly in line or with a predetermined gap. Or as illustrated in FIG. 4, both ends 4 and 5 are fixed to overlap by a small amount. As in FIG. 4, when both ends 4 and 5 are fixed to overlap each other, a seam 3 is stepped up by about 210-450 μm from the outer circumference of the cylindrical body 1. For example, the photosensitive sheet 2 in which a photosensitive layer of about 25 μm thickness is formed on the PET sheet where the thickness of the PET sheet including an electrically conductive metal layer is about 110 μm is adhered around the cylindrical body 1 with a 120 mm long diameter using a double-sided adhesive sheet that is about 50 μm thick. In this case, the surface of the photosensitive sheet 2 is stepped up by about 180 μm from the outer circumference of the cylindrical body 1. Also, when the seam 3 is formed as illustrated in FIG. 4, the seam 3 will be stepped up by about 360 μm from the outer circumference of the cylindrical body 1.

In order to lessen the impact applied to the transfer belt 105, the seam 3 can be inclined with respect to the longitude of the photosensitive drum 101, as illustrated in a solid line in FIG. 2. Since an effective image forming area may decrease if the seam 3 is inclined to greatly with respect to the longitude of the photosensitive drum 101, a length difference L between both ends of the seam 3 should be about from 1/50 to ¼ of the diameter of the photosensitive drum 101 and may be between 1/30 and 1/15. The thickness of the photosensitive sheet 2 is very small as compared to the diameter of the cylindrical body 1. Therefore, the diameter of the cylindrical body 1 can be the basis for setting the length difference L of the inclined seam 3. In the present embodiment, the length difference L is 1/12 of the diameter of the cylindrical body 1, which is about 10 mm.

As illustrated in FIGS. 2, 5, and 6, a spacer 20 is disposed respectively on both ends of the cylindrical body 1. The spacer 20 is to distance the electrostatic charging roller 102 and/or the developing roller 106 from the seam 3 of the photosensitive sheet 2 so that the electrostatic charging roller 102 and/or the developing roller 106 does not come in contact with the seam 3 of the photosensitive sheet 2. For example, the spacer 20 may be fixed to the cylindrical body 1 with a screw S. As the seam 3 approaches the electrostatic charging roller 102 and/or the developing roller 106, the spacer 20 smoothly pushes back the electrostatic charging roller 102 and/or the developing roller 106 to create a distance from the seam 3, and when the seam 3 passes the electrostatic charging roller 102 and/or the developing roller 106, the electrostatic charging roller 102 and/or the developing roller 106 smoothly return to the original position. Therefore, as illustrated in FIG. 5, the spacer 20 may have a shape of a smooth curve or a mountain with a smooth slope. To sufficiently distance the electrostatic charging roller 102 and/or the developing roller 106 from the seam 3, a height difference H of the surface of the photosensitive sheet 2 and a peak 21 of the spacer 20 should be more than 100 μm, and may be between 200 and 800 μm and not to exceed 1 mm. A width W of the spacer 20 should be wide enough to sufficiently prevent the seam 3 of the photosensitive sheet 2 from contacting the electrostatic charging roller 102 and/or the developing roller 106. When considering these conditions, the width W of spacer 20 should be from 5 to 30 mm, for example, from 10 to 25 mm.

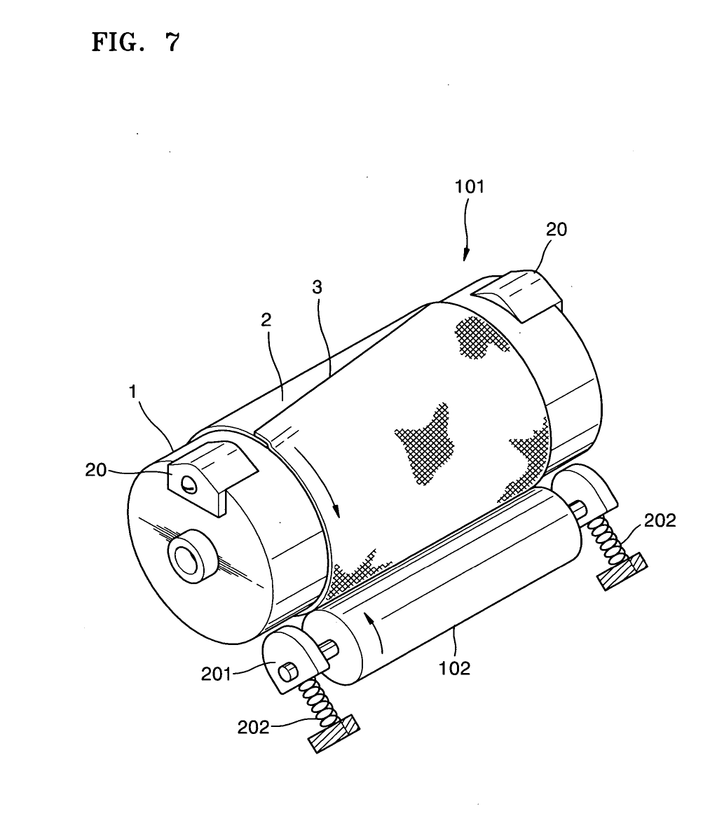

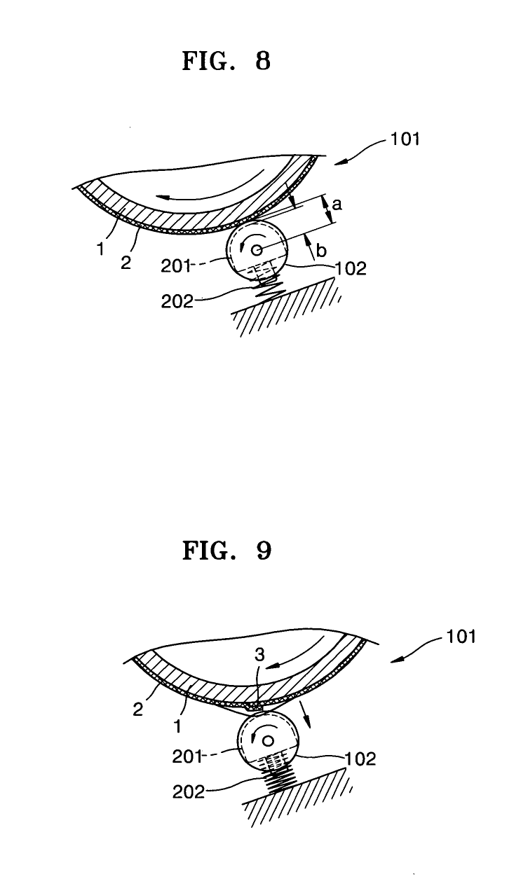

FIG. 7 is a perspective view illustrating a relationship between the photosensitive drum 101 and the electrostatic charging roller 102. FIGS. 8 and 9 are cross-sectional views of the lower portion of FIG. 7. Referring to FIGS. 7 and 8, a bearing unit 201 supports both ends of the electrostatic charging roller 102. An elastic member 202 electrically biases the bearing unit 201 in the direction of the electrostatic charging roller 102 so that the bearing unit 201 contacts the photosensitive sheet 2. The bearing unit 201 meets the cylindrical body 1 outside the photosensitive sheet 2. As the photosensitive drum 101 rotates, the seam 3 of the photosensitive sheet 2 moves closer to the electrostatic charging roller 102. Then, the spacer 20 comes in contact with the bearing unit 201 and pushes back the bearing unit 201 as illustrated in FIG. 9. Consequently, the electrostatic charging roller 102 is distanced from the photosensitive sheet 2. As the photosensitive drum 101 continues to rotate and the seam 3 passes, the interference of the spacer 20 and the bearing unit 201 ends and the electrostatic charging roller 102 comes in contact with the photosensitive sheet 2 again.

The distance from the center of the electrostatic charging roller 102 to the surface of the electrostatic charging roller 102 (or the radius of the electrostatic charging roller 102) is “a”(FIG. 8) while the distance from the center of the electrostatic charging roller 102 to the edge of the bearing unit 201 is “b.” In the case where the thickness of the photosensitive sheet 2 is less than 150 μm and the length of “a” and “b” are identical, the electrostatic charging roller 102 cannot sufficiently contact the photosensitive sheet 2. Therefore, “b” should be smaller than “a” by no more than 1 mm. When the thickness of the photosensitive sheet 2 is more than 150 μm, the electrostatic charging roller 102 can sufficiently contact the photosensitive sheet 2. In some cases, however, “b” may be slightly smaller than “a.” A height difference between “b” and the distance from the surface of the photosensitive sheet 2 to the spacer 20 should be set so that the electrostatic charging roller 102 is distanced enough from the seam 3 and does not contact the seam 3.

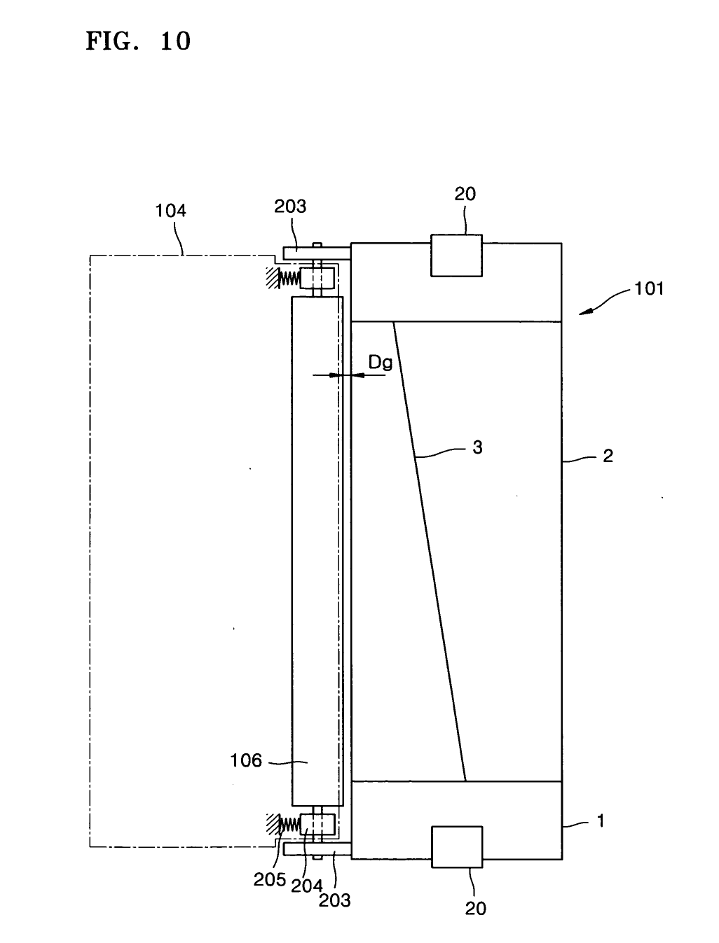

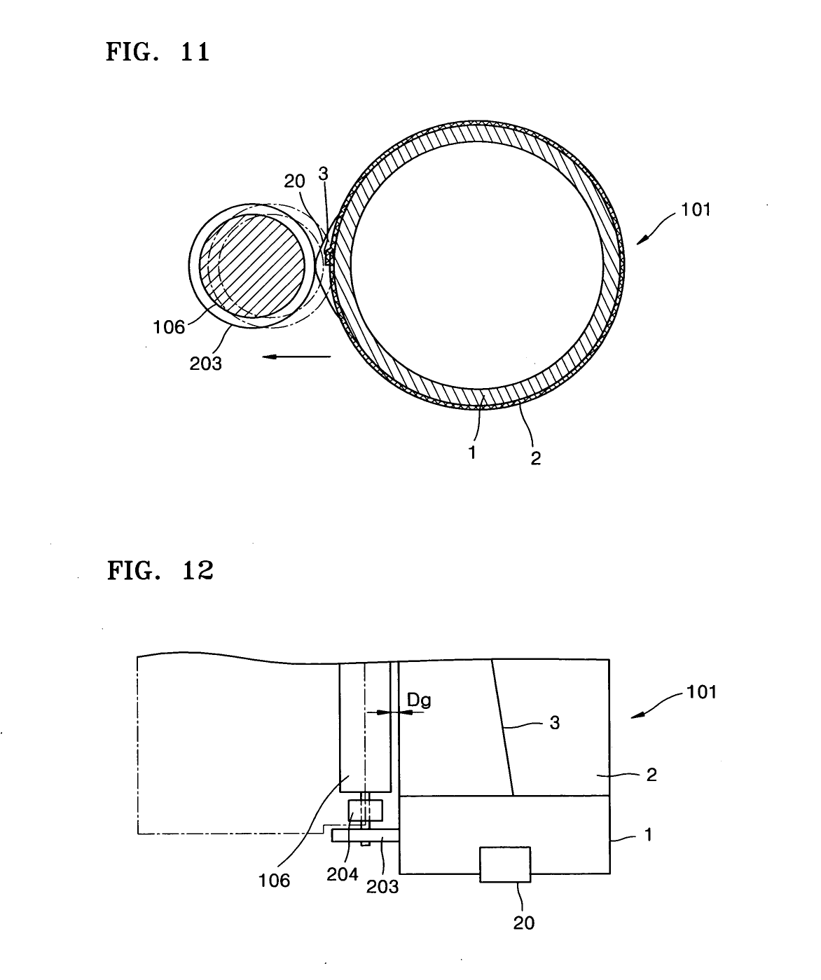

FIG. 10 is a plan view illustrating a relationship between the photosensitive drum 101 and the developing roller 106. FIG. 11 is cross-sectional view of the lower portion of FIG. 10. FIG. 10 illustrates one example of a non-contact developing method where the developing roller 106 is distanced as much as a developing gap Dg from a photosensitive medium for a developing process. Referring to FIG. 10, the developer 104 elastically supports the developing roller 106 with a bearing unit 204 and an elastic member 205. A rotatable gap controlling roller 203 is disposed on both ends of the developing roller 106. The gap controlling roller 203 is to maintain the surface of the developing roller 106 and the surface of the photosensitive sheet 2 to be as distant as much as the developing gap Dg. The gap controlling roller 203 comes in contact with both ends of the cylindrical body 1. The diameter of the gap controlling roller 203 is longer than the diameter of the developing roller 106 by as much as the sum of the thickness of the photosensitive sheet 2 and the developing gap Dg. Typically, the developing gap Dg is from 50 to 500 μm.

As the photosensitive drum 101 rotates, the seam 3 of the photosensitive sheet 2 moves toward the developing roller 106. When the spacer 20 comes in contact with the gap controlling roller 203, the spacer 20 pushes back the gap controlling roller 203. Then, the developing roller 106 is pushed back in the direction illustrated in FIG. 11 and is distanced from the photosensitive sheet 2. When the photosensitive drum 101 continues to rotate and the seam 3 passes, interference of the spacer 20 and the gap controlling roller 203 terminates, and the developing roller 106 returns to a position to maintain the developing gap Dg with the photosensitive sheet 2. In the case where the developing gap Dg is sufficiently larger than the thickness of the photosensitive sheet 2, the developing roller 106 and the seam 3 do not come in contact with each other and so the developing roller 106 does not necessarily need to be distanced from the seam 3. Therefore, in this case, the gap controlling roller 203 and the spacer 20 should be in place so that the gap controlling roller 203 and the spacer 20 do not interfere with each other, as illustrated in FIG. 12.

According to the above-mentioned structure, the damage caused by repetitive contact with the seam 3 of the photosensitive sheet 2 to the electrostatic charging roller 102 and the developing roller 106 can be prevented. Consequently, the electrostatic charging roller 102 may be used to charge the photosensitive drum 101 with the photosensitive sheet 2 fixed on the cylindrical body 1. Therefore, harmful substances produced during the charging process can be decreased and stable charging characteristics can increase the quality of the developed image. Also, by using the photosensitive drum 101 that is produced at a moderate price, the price of the image forming apparatus may be lowered. According to the result of continuously printing 10,000 pages using the developing gap Dg of 150 μm, there was hardly any damage to the electrostatic charging roller 102 and the developing roller 106, and satisfactory image quality was obtained.

The photosensitive drum 101 with above-mentioned structure can also be used in an image forming apparatus with a contact type developing method where the developing roller 106 comes in contact with the photosensitive drum 101 to develop an image. For example, in FIG. 10, the developing roller 106 comes in contact with the surface of the photosensitive sheet 2 if the radius of the gap controlling roller 203 is either the same or smaller than the radius of the developing roller 106. As the photosensitive drum 101 rotates, the seam 3 of the photosensitive sheet 2 comes closer to the developing roller 106. Then, the spacer 20 comes in contact with the gap controlling roller 203 and pushes back the gap controlling roller 203. As a result, the developing roller 106 is distanced from the photosensitive sheet 2. As the photosensitive drum 101 continues to rotate and the seam 3 passes, then the interference by the spacer 20 and the gap controlling roller 203 terminates and the developing roller 106 re-contacts the photosensitive sheet 2. According to the described structure, the damage to the electrostatic charging roller 102 and the developing roller 106 caused by contacting the seam 3 of the photosensitive sheet 2 can be prevented. The result of continuously printing 10,000 papers with the image forming apparatus with the described structure shows that there was little damage to the electrostatic charging roller 102 and the developing roller 106, and satisfactory image quality was achieved.

In the described image developing apparatus, there is a need to make sure that the image does not form on the seam 3 of the photosensitive sheet 2. A sensor (not shown) that detects the seam 3 of the photosensitive sheet 2 may be used.

The present invention is not limited to the described embodiment where a single color image forming apparatus having one developer 104 was described. The described embodiment can be applied to a color image developing apparatus that has four developers with toners for the colors: cyanogens, magenta, yellow, and black or combinations thereof.

According to the embodiment of the present invention, the following effects may be achieved when using a photosensitive drum with a fixed photosensitive sheet on a cylindrical body as a photosensitive medium, a spacer can prevent damage to an electrostatic charging roller and/or a developing roller. Also, the electrostatic charging roller can be used to charge the photosensitive drum. This decreases the amount of harmful substances produced during a charging process and stable charging characteristics help to improve the quality of the image. In addition, by using the photosensitive drum that is produced at a moderate price, the price of an image forming apparatus can be lowered.

Although an embodiment of the present invention has been shown and described, it would be appreciated by those skilled in the art that changes may be made in this embodiment without departing from the principles and spirit of the invention, the scope of which is defined in the claims and their equivalents.

1. A photosensitive drum comprising: a cylindrical body;
a fixed photosensitive sheet to define an image forming area on an outer circumference of the cylindrical body and including a seam; and
a spacer disposed on an end of an outer portion of the image forming area on the cylindrical body to push an electrostatic charging roller or a developing roller, which access the photosensitive sheet during an image forming process, when the seam of the photosensitive sheet approaches, to thereby make distant the seam from the electrostatic charging roller or the developing roller.

2. An electrophotographic image forming apparatus comprising:
a photosensitive drum, comprising:
a cylindrical body, and
a fixed photosensitive sheet defining an image forming area on an outer circumference of the cylindrical body and comprising a seam; and
an electrostatic charging roller that rotates in contact with the photosensitive sheet and charges a uniform electrostatic potential on a surface thereof,
wherein the photosensitive drum further comprises a spacer disposed on an end of an outer portion of the image forming area on the cylindrical body to, thereby distance the electrostatic charging roller from the seam of the photosensitive sheet by pushing the electrostatic charging roller when the seam of the photosensitive sheet approaches the electrostatic charging roller.

3. The electrophotographic image forming apparatus of claim 2, further comprising:
a bearing unit that supports the electrostatic charging roller; and
an elastic member that gives an elastic force to the bearing unit in a direction so that the electrostatic charging roller contacts the photosensitive sheet,
wherein the spacer pushes the bearing unit to distance the electrostatic charging roller from the seam of the photosensitive sheet.

4. The electrophotographic image forming apparatus of claim 2, further comprising a developing roller that supplies a developing material to an electrostatic latent image formed on the photosensitive sheet, wherein the spacer pushes the developing roller as the seam of the photosensitive sheet approaches the developing roller to distance the developing roller from the seam of the photosensitive sheet.

5. The electrophotographic image forming apparatus of claim 4, further comprising a rotatable gap controlling roller that is disposed on opposite ends of the developing roller and in contact with ends of an outer portion of the image forming area on the cylindrical body to maintain a developing gap between the surface of the photosensitive sheet and the outer circumference of the developing roller, wherein the spacer pushes the gap controlling roller to distance the developing roller from the seam of the photosensitive sheet.

6. The electrophotographic image forming apparatus of claim 4, further comprising:
a bearing unit that supports ends of the developing roller; and
an elastic member that gives an elastic force to the bearing unit so that the developing roller can rotate in contact with the photosensitive sheet,
wherein the spacer pushes the bearing unit to distance the developing roller from the seam of the photosensitive sheet.

7. The electrophotographic image forming apparatus of claim 2, further comprising:
a developing roller that is spaced apart as much as a developing gap between the surface of the photosensitive sheet and the developing roller, and supplies a developing material to an electrostatic latent image formed on the surface of the photosensitive sheet to develop the image; and
a rotatable gap controlling roller that is disposed on both ends of the developing roller and is in contact with both ends of the outer portion of the image forming area on the cylindrical body to maintain a developing gap between the surface of the photosensitive sheet and the outer circumference of the developing roller,
wherein the spacer and the gap controlling roller are placed so as to not interfere with each other.

8. An apparatus comprising:
a cylinder;
a photosensitive sheet surrounding the cylinder to form a seam; and
a spacer on an end of the cylinder projecting radially therefrom and opposite the seam.

9. The apparatus of claim 8, further comprising a roller to selectively rotate in contact with the photosensitive sheet to charge the photosensitive sheet, wherein the spacer separates the roller from the photosensitive sheet when the roller rotates past the seam.

10. The apparatus of claim 8, further comprising a roller to selectively rotate in contact with the photosensitive sheet to supply toner to the photosensitive sheet, wherein the spacer separates the roller from the photosensitive sheet when the roller rotates past the seam.

11. The apparatus of claim 8, wherein the spacer comprises first and second projections on opposite sides of the cylinder, the seam being between the first and second projections.

12. The apparatus of claim 8, wherein the seam comprises opposite ends of the sheet being overlapped.

13. The apparatus of claim 8, wherein the spacer has a shape of a smooth curve or a mountain with a smooth slope.

14. The apparatus of claim 10, further comprising:
a bearing to support the roller; and
a bias element to exert a force on the bearing to bias the roller to contact the photosensitive sheet,
wherein a force of the spacer on the bearing overcomes the force of the bias element as the roller rotates past the spacer to thereby separate the roller and the photosensitive sheet.
